(19) United States
(12) Patent Application Publication
(10) Pub. No.: US 2004/0043213 A1
(43) Pub. Date: Mar. 4, 2004

(54) Method for the production of a carbon fiber-based reinforcing element for tires

(75) Inventor: Corinne Tonon, Crest (FR)

Correspondence Address: BURR & BROWN, PO BOX 7068, SYRACUSE, NY, 13261-7068, US

(73) Assignee: Sovoutri Societe Voultaine De Transformes Industriels, Bourgoin Jallieu (FR)

(21) Appl. No.: 10/460,976

(22) Filed: Jun. 13, 2003

Related U.S. Application Data
(63) Continuation of application No. PCT/FR01/04208, filed on Dec. 26, 2001.

(30) Foreign Application Priority Data
Jan. 12, 2001 (FR) 01.00379

(51) Int. Cl. D02G 3/36; D02G 3/48; D02J 1/18; B60C 9/00; B32B 9/00

(52) U.S. Cl. 428/367; 19/65 T; 19/299; 28/282; 57/250; 57/251; 57/292; 264/103; 264/137; 264/171.1; 152/451

(57) ABSTRACT

A method for the production of a multifilament carbon fibre-based longitudinal reinforcing element, designed to be incorporated in a rubber-based item. Said method comprises the following steps, whereby untwisted carbon fibres are plunged into an impregnating bath contained a solution of resorcinol-formaldehyde resin and rubber latex, the impregnated fibres are then dried and the dried fibres are subsequently twisted. The inventive method is characterised by the fact that it also comprises a step, during the impregnation step, consisting in opening out the carbon fibres by spreading out the constituent filaments thereof in such a way that each fibre has an increased surface area on which the impregnation can be performed.

### TECHNICAL FIELD

The invention relates to the field of the textile industry. More precisely, it relates to the sector concerned with the manufacture of reinforcing elements to be incorporated into rubber-based articles, such as automobile belts, and hoses or tires. It relates more specifically to a process for treating a carbon fiber allowing the properties of this fiber to be optimized, especially in terms of elongation and tensile strength.

In the rest of the description, the term “carbon fiber” will be used to denote a continuous multifilament yarn of carbon.

### PRIOR ART

As is known, many rubber-based articles, such as belts or tires, are subjected to high tensile stresses. This is why they are generally reinforced with glass or carbon strands embedded in the rubber.

It has been proposed in document U.S. Pat. No. 6,077,606 to use carbon fibers as reinforcing elements for tires.

The fibers described in that document are obtained by a process involving several steps. In a first step, the fibers are dipped into an impregnation bath containing an epoxy resin. In a second step, the fibers are impregnated a second time with a solution containing a mixture of resorcinol-formaldehyde resin and a rubber latex, this mixture being commonly denoted by the compact expression “resorcinol-formaldehyde latex” or by the abbreviation “RFL”. After drying the RFL impregnation, the fibers are twisted. The twisting of these fibers may take place even before the various impregnations.

Such a process has certain drawbacks. This is because it has been found that when the fibers are immersed in the impregnation baths, the RFL (or epoxy resin) solution does not penetrate to the core of the fiber and that only the peripheral filaments are coated. It follows that the filaments located at the core of the fibers are devoid of any protective cover. This phenomenon is even more pronounced when the fibers are immersed in the impregnation baths after they have been twisted. This results in a low tensile strength of the fiber and, in dynamic operation, many fractures of the internal filaments are observed, hence poor fatigue behavior.

Document U.S. Pat. No. 5,807,194 describes a process specific to the use of carbon fibers for timing belts. More precisely, that document describes the use of a urethane solution mixed with the rubber that forms the belt. This urethane solution tends to penetrate the carbon fibers and occupy the interstices between the various filaments. Unfortunately, this technique does not allow the core fibers to be sufficiently impregnated, and the tensile strength problems already mentioned remain.

One of the problems that the invention aims to solve is that of the relatively low tensile strength of the carbon fibers due to a defect in the production of the filaments located at the core of the fiber.

### SUMMARY OF THE INVENTION

The invention therefore relates to a process for manufacturing a longitudinal reinforcing element based on multifilament carbon fibers, to be incorporated into a rubber-based article.

As is known, such a process includes the following steps, consisting, starting from twist-free carbon fibers:

in immersing the fibers in an impregnation bath containing a solution of resorcinol-formaldehyde resin and of rubber latex;

in drying the fibers thus impregnated;

then in twisting the dried fibers.

According to the invention, this process also includes a step that consists, during the impregnation step, in opening the carbon fibers by spreading the constituent filaments so that each fiber has an increased surface area on which the impregnation may take place.

In other words, the invention consists in deforming the carbon fiber by spreading out its various filaments as much as possible in order to allow each filament to be covered with an RFL layer, including the filaments located at the core of the fiber, after impregnation.

It has been observed that many of the filaments of the fibers that have undergone the process according to the invention are coated with the dried resorcinol-formaldehyde-latex composition. The impregnation thus carried out takes place very deeply, typically beyond the tenth filament layer.

In practice, by opening the fibers during the impregnation step, the lubricating properties of the impregnation bath are put to good use, thus avoiding the risks of filament breakage.

The step of opening the fibers may be carried out in various ways.

Thus, this opening of the fibers may be obtained by splaying. By splaying is meant that the yarn is forced to adopt a path such that it rubs against obstacles and tends to spread out in order to reduce the tension exerted on each filament. Such splaying must be done under sufficient tension for the filaments to spread out with respect to one another, but this tension must not be too high as the filaments cannot spread out further, and the risks of filament fracture increase.

In one particular embodiment, the splaying may be obtained by passing the fibers around part of the circumference of at least one bar placed perpendicular to the path of the fibers.

In other words, the bar or bars placed along the path of the fiber form chicanes around which the fiber has to pass. By passing around the bars, the fibers have a tendency to open, and the various filaments spread out to occupy most of the line of contact with the bar.

The number, the shape and the separation of the various bars are determined according to the linear density of the fibers and their type, for example the number of filaments per fiber.

In an alternative embodiment, the splaying may be combined with a vibrating treatment. When the vibrations are generated at a resonant frequency of the fiber, they cause the fibers to open. The splaying bars may, for example, be coupled to a source of vibration, thereby allowing the fiber opening effect due to the rubbing on the bars to be combined with the opening effect due to the vibrations.

Advantageously, in practice, in the resorcinol-formaldehyde-latex (RFL) solution, the fraction of resorcinol-formaldehyde resin represents from 2 to 30% by dry weight, the fraction of latex representing from 70 to 98%. Preferably, the fraction of resorcinol-formaldehyde resin represents from 5 to 10% by dry weight, the latex fraction representing from 80 to 95%. To adapt the strength and, to a lesser extent, the adhesion of the fiber, it is possible to add carbon black to the RFL solution. In practice, the fraction of carbon black then represents from 0 to 10% by dry weight, preferably from 1 to 4% by dry weight, the fraction of resorcinol-formaldehyde resin and the fraction of latex remaining in the same ratio.

Consequently, the impregnation solution allows the various filaments of the fiber to be impregnated sufficiently so as to protect them from abrasion and from fracture, while maintaining sufficient flexibility necessary for the twisting or cabling operations.

Advantageously in practice, and especially when the fiber obtained is to reinforce tires, the latex used may be vinylpyridine/styrene-butadiene (VP/SBR), styrene-butadiene (SBR) or latex of natural rubber (NR), by themselves or as a mixture. When the carbon fibers are to be embedded in rubber for producing belts, the latex used may advantageously be carboxylated and hydrogenated acrylonitrile-butadiene (X-HNBR), hydrogenated acrylonitrile (HNBR), acrylonitrile (NBR), ethylene-propylene-diene monomer (EPDM), chlorosulfonated polyethylene (CSM), or even vinylpyridine/styrene-butadiene (VP/SBR) or styrene-butadiene (SBR), by themselves or as a mixture.

In a preferred embodiment, the process according to the invention may include, after the impregnation step and before the drying step, a step of sizing the coating. This sizing allows the excess solution that was entrained during impregnation to be removed.

After sizing, the fiber retains only a small amount of the RFL solution, the superfluous amount thus being removed. The subsequent drying of the fiber takes place only for the optimum amount of RFL solution. The stiffness of the dried fiber is therefore controlled in order to facilitate the subsequent twisting/cabling operations.

In practice, the coating is sized by passing the fibers through a die. Passing them through a die furthermore makes it possible to assemble the various filaments that remain separated after impregnation. Furthermore, passage through a die allows the solution to be pressed into the fiber and ensures better impregnation at the core. The fiber obtained on leaving the die is more round, which proves to be beneficial for the subsequent operations.

The invention also covers the variants in which the coating is sized by padding or an equivalent process.

In certain particular embodiments, it may prove beneficial, after the drying step, to heat the fibers so as to be able to cure the fraction of resorcinol-formaldehyde resin/latex solution impregnated into the fibers. This curing, corresponding to crosslinking of the RFL, is carried out after the drying that had evaporated most of the water from the impregnation solution remaining on the fibers.

After the drying and curing, the fibers are twisted and then possibly combined into several ends, which are then cabled. The twisting and the cabling may take place in line with the oven or on an independent machine.

Advantageously in practice, the cabling/twisting is carried out under tension. Preferably, a high tension value, typically greater than 5% of the load at break of the fiber, will be chosen. This is because it has been found that such tensioning during twisting allows a number of filaments to be realigned. In the fibers of the prior art, a slight elongation, of the order of a few tenths of a percent, is in fact observed when tension is exerted on the fiber. This initial elongation must be taken into account in the properties of the rubber article incorporating such fibers. The twisting under high tension according to the invention allows the influence of this initial elongation to be eliminated.

Advantageously, for the carbon fiber to be used in certain articles such as, in particular, timing belts, it may prove advantageous for the method according to the invention to furthermore include an additional step of impregnating the cabled or twisted fiber with an adhesive in a solvent medium. This step makes it possible to obtain an additional layer covering the fiber. This additional layer, forming a ring around the fiber, is particularly advantageous for ensuring good adhesion to certain types of rubber, such as acrylonitrile (NBR), hydrogenated acrylonitrile (HNBR), carboxylated hydrogenated acrylonitrile (X-HNBR), vulcanizable hydrogenated acrylonitrile (ZSC), chlorosulfonated polyethylene (CSM), alkylated chlorosulfonated polyethylene (ACSM) and ethylenepropylene-diene monomer (EPDM).

In practice, the adhesive in a solvent medium is a blend of polymers, possibly halogenated polymers, organic compounds, such as isocyanates, and mineral fillers, such as carbon black.

The fibers obtained according to the invention may be incorporated into many articles, such as tires and timing belts, or else into rubber hoses subjected to high pressure.

### BRIEF DESCRIPTION OF THE FIGURES

The manner in which the invention is realized and the advantages that stem therefrom will become clearly apparent from the description of the following embodiment in conjunction with the appended figures in which:

FIG. 1 is a schematic general view of the path of a fiber during its treatment according to the invention;

FIGS. 2 and 3 are summary perspective views in detail of two different mechanisms for opening the fibers according to the invention.

### MANNER OF IMPLEMENTING THE INVENTION

As already mentioned, the invention relates to a process for treating carbon fibers for the purpose of obtaining longitudinal reinforcing elements that will be embedded within rubber articles, such as timing belts or tires for example.

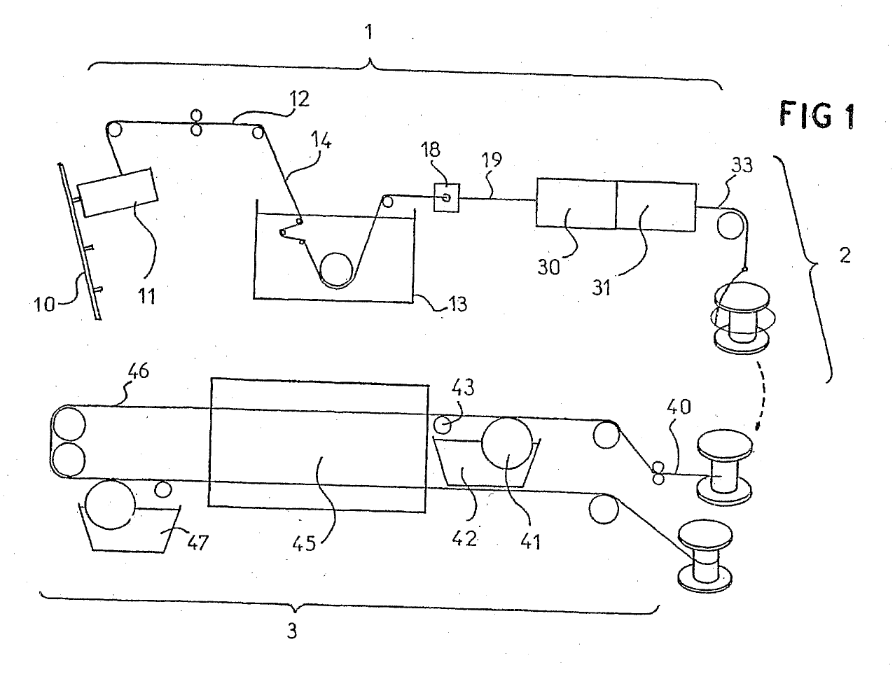

As illustrated in FIG. 1, the process may be implemented on a treatment line comprising three separate zones, namely:

a first zone (1) in which the impregnation or adhesion is carried out;

a second zone (2) in which the fibers from the first zone (1) are twisted or cabled; and

a third zone (3) in which the cabled fibers undergo a complementary treatment, for some applications.

More precisely, the carbon fibers used are paid out from a creel (10) on which they are wound, twist-free, as balls or on bobbins (11). The creels used have a tension -control device which may advantageously be a dancer arm. The tension with which the fiber (12) from the creel is paid out must be high enough to allow the fibers to open during the splaying that follows, but must not exceed a limit above which the fiber remains grouped together and even runs the risk of certain filaments breaking.

The carbon fibers used may vary greatly and may have, for example, a linear density of between 198 tex and 1700 tex and a number of filaments per fiber of between 3000 and 24 000.

In the embodiment illustrated in FIG. 1, the fibers paid out from the creel (10) are taken into an impregnation bath (13). After having penetrated the bath (13), the fibers (14) undergo an opening operation allowing the various filaments constituting the fiber to be separated and spread out side by side.

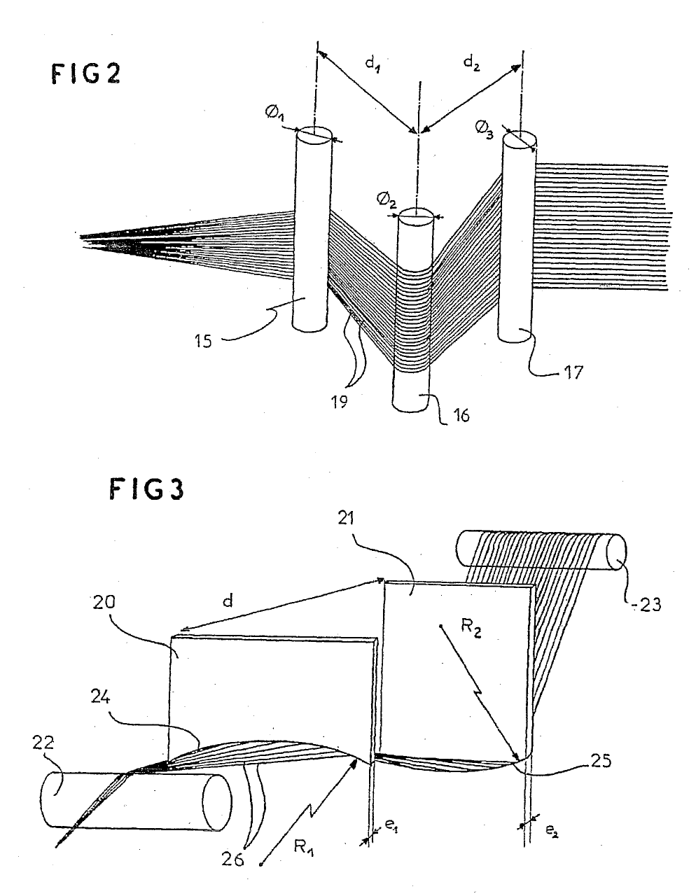

Various mechanisms may allow such an opening of the fibers to be achieved, such as those for example illustrated in FIGS. 2 and 3.

Thus, as illustrated in FIG. 2, such a mechanism may comprise three stationary bars (15, 16, 17) forming a spreader. The diameter (φ1, φ2, φ3) and the distance (d1, d2) separating two consecutive bars may be adjusted in order to ensure that the fibers are properly opened. It is therefore possible to adjust the area over which the rubbing between the various filaments (19) and the bars takes place, depending on the type of fiber used, especially its linear density and the number of filaments per fiber.

Of course, the invention is not limited to the single embodiment illustrated in FIG. 2, in which the opening mechanism comprises three bars, rather it covers alternative embodiments operating with one bar or more than two bars.

Another alternative embodiment of the mechanism for opening the fibers is illustrated in FIG. 3. Such a mechanism essentially comprises two stationary plates (20, 21) located between two rollers (22, 23) that are free to rotate. These two plates (20, 21) have edges (24, 25) on which the various filaments (26) rub. These two edges are shaped, being concave in the case of the first edge (24) and convex in the case of the second edge (25). The radii of curvature (R1, R2) of the edges on which the filaments rub are about 10 to 50 mm.

The distance (d) between the two plates (20, 21), their thicknesses e₁ and e₂ and the relative position of the concave edge (24) and convex edge (25), and therefore the angles imposed on the path of the filaments (26), may be adjusted according to the linear density and the number of filaments per fiber.

Of course, the invention is not limited to the single embodiment illustrated in FIG. 3, in which the opening mechanism comprises two plates, rather it covers alternative embodiments operating with one plate or more than one plate, or also plates combined with bars.

As already mentioned, the operation of opening the fibers may take place preferably as illustrated in FIG. 1, that is to say entirely inside the impregnation bath (13), but it may also start just before the fibers enter the impregnation bath, so as to initiate the spreading of the filaments. The opening of the fibers is continued within the impregnation solution, and the filaments therefore spread out when they are within the solution. The lubricating effect of the impregnation solution is then put to good use during the stage in which the separated filaments each rub on the bars or the plates.

The fiber, after having been opened out into the form of a web of parallel filaments, continues its path through the impregnation bath (13). It is then taken to a die (18) which gathers the various filaments into a fiber (19) of approximately circular cross section, and the fiber is wiped in order to remove the excess impregnation solution.

The die (18) has an adjusted diameter. It may be replaced with a wiper roller.

Next, the fiber is taken into an oven (30), which may be vertical or horizontal. This oven (30) operates by forced convection. The objective of the drying oven is to remove the water, still present on the fiber, coming from the impregnation solution.

In the embodiment illustrated in FIG. 1, the drying oven (30) is placed upstream of a curing oven (31) in which the temperature causes the fraction of resorcinol-formaldehyde-latex remaining impregnated in the fibers to cure.

The curing may also be carried out concomitantly with the drying, by exposure to a temperature high enough to ensure both evaporation of the water vapor and curing. The drying and the curing may therefore be carried out in a single oven.

On leaving the drying and/or curing oven, the treated fiber (33) is twisted. This twisting operation is preferably carried out under high tension, in order to allow the various filaments that might not be in alignment with the others to adopt the principal orientation. In some applications, it may prove beneficial to assemble various fibers after twisting and then to cable them. For some uses, and especially for timing belts, the fibers may receive, in the third zone (3), an additional treatment consisting in impregnating them with an adhesive in a solvent medium and then in evaporating the solvents.

More precisely, this second impregnation may take place, as illustrated in FIG. 1, by passing the cabled fibers (40) over a coating roll (41) partly immersed in the adhesive (42) in a solvent medium. After the fibers have passed over the coating roll (41), they pass over a wiper roller (43) which removes the excess amount of the second impregnation. The fiber thus coated then passes into a drying oven (45), which evaporates the solvents. On leaving the oven, the fiber (46) may again be impregnated with the same adhesive in a solvent medium, by passing through a similar device (47), and then finally dried. The fiber is then wound up (48) for being used.

Eight particular illustrative examples for various impregnation solutions and various adjustments are described below.

### EXAMPLE 1

A fiber sold by Toray under the reference TORAYCA-400 HB 40D 6K, corresponding to a yarn of 400 tex overall linear density and comprising 6000 filaments, was used. The tension with which the fiber was delivered from the creel was 20 grams. Each fiber was splayed out by two bars 1 millimeter in diameter, separated by 39 mm, that were immersed in the impregnation solution.

The impregnation solution was obtained by mixing:

a first part A composed of:

53.2 liters of deionized water,

0.9 liters of 30.5% sodium hydroxide of the Vaissière Favre brand,

5.8 liters of 37% formaldehyde of the Vaissière Favre brand,

22.2 kilograms of PENACOLITE of reference R-2170 (75% concentration) sold by Indspec Chemical Corp.;

a second part B composed of:

400 kilograms of PLIOCORD VP106 latex (40%) sold by Goodyear Chemicals,

43 liters of 20.5% aqueous ammonia sold by Vaissière Favre,

34 kilograms of HEVEAMUL M111B wax (45%) sold by Heveatex,

200 kilograms of PLIOCORD SB2108 (40%) sold by Goodyear Chemicals, and

100 liters of deionized water.

To obtain the impregnation solution ready to be used, the mixture thus obtained was diluted so as to have a solids content of 317 g/kg.

The speed of the fibers through the impregnation bath was about 20 meters per minute. On leaving the impregnation bath, the yarn was passed through a die 0.81 millimeters in diameter.

The fiber then passed through a curing oven at a temperature of 280° C. The length of the oven was 3 meters. On leaving the oven, the fiber had a coating, corresponding to the amount of cured impregnation solution material, representing approximately 19% by dry weight of the yarn.

The fibers thus obtained were then twisted with 70 turns per meter, under a tension of greater than 0.5 kg.

A fiber having the following mechanical properties was thus obtained: load at break: 42.40 kg; elongation at break: 1.46%; elongation under a load of 30% of the load at break: 0.79%. This fiber was particularly suitable for being incorporated into tires.

### EXAMPLE 2

A fiber sold by Toray under the reference TORAYCA-700 GC 4 12K, corresponding to a yarn of 800 tex overall linear density and comprising 12 000 filaments, was used. The tension with which the fiber was delivered from the creel was 45 grams. Each fiber was splayed out by three bars 1 millimeter in diameter arranged in an isosceles triangle with a base of 20 mm and a height of 8 mm placed a few centimeters before the impregnation tank, and two bars 1 mm in diameter separated by 34 mm immersed in the impregnation tank.

The impregnation solution was the same as that of example 1, with a solids content adjusted to 330 g/kg.

The speed of the fibers through the impregnation bath was about 20 meters per minute. On leaving the impregnation bath, the yarn was passed through a die 1.1 millimeters in diameter and the fiber then passed through a curing oven, again at a speed of 20 meters per minute. The temperature of the oven was 280° C. The length of the oven was 3 meters. On leaving the oven, the fiber had a coating, corresponding to the amount of cured impregnation solution material, representing approximately 17.4% by dry weight of the yarn.

The fiber thus obtained was then twisted with 80 turns per meter, under a tension of greater than 0.5 kg.

A fiber having the following mechanical properties was thus obtained: load at break: 99.10 kg; elongation at break: 2.75%; elongation under a load of 30% of the load at break: 1.27%. This fiber was particularly suitable for being incorporated into tires.

### EXAMPLE 3

A fiber sold by Toray under the reference TORAYCA-400 HB 40D 6K, corresponding to a yarn of 400 tex overall linear density and comprising 6000 filaments, was used. The tension with which the fiber was delivered from the creel was 50 grams. Each fiber was splayed out by three bars 1 millimeter in diameter arranged in an isosceles triangle with a base of 20 mm and a height of 8 mm placed a few centimeters before the impregnation tank, and two bars 1 mm in diameter separated by 34 mm immersed in the impregnation tank.

The impregnation solution was obtained by mixing:

a first part A composed of:

36 liters of deionized water,

4 liters of 20.5% aqueous ammonia of Vaissière Favre brand,

10 kilograms of PENACOLITE of reference R2170 (75% concentration) sold by Indspec Chemical Corp.,

27.2 kilograms of 41% urea of Vaissière Favre brand;

a second part B composed of:

36 liters of deionized water,

286 kilograms of Zetpol B latex sold by Nippon Zeon; and

a third part C composed of:

16 liters of deionized water,

3.2 kilograms of 37% formaldehyde of Vaissière Favre brand.

Next, 18 kilograms of HEVEAMUL M-111b wax (45%) sold by Heveatex were added.

To produce the final impregnation solution, the above mixture was diluted so as to have a solids content of 330 g/kg.

The speed of the fibers through the impregnation bath was about 40 meters per minute. On leaving the impregnation bath, the yarn was passed through a die 0.81 millimeters in diameter and the fiber then passed through a drying oven, again at a speed of 40 meters per minute. The temperature of the drying oven was 146° C. The length of the drying oven was 3 meters. On leaving the drying oven, the fiber passed through a curing oven, again at a speed of 40 m/min. The temperature of the curing oven was 267° C. The length of the curing oven was 5 meters. The fiber had a coating, corresponding to the amount of cured impregnation solution material, representing approximately 20.4% by dry weight of the yarn.

The fibers thus obtained were then assembled in pairs and twisted with 80 turns per meter. This twisting operation was carried out under a tension close to 50 kg. A two-fiber assembly was Z-twisted and a fiber assembly was S-twisted.

Next, the cabled yarn thus obtained underwent an additional treatment. Thus, the cabled yarn was paid out under a tension of about 1 kilogram. It was impregnated with a solution comprising 8.1% of a composition sold by Henkel under the reference CHEMOSIL X2410 in xylene. After impregnation, the fiber passed through an oven 8 meters in length at a temperature of 90° C. The speed of the yarn through the oven was 18 meters per minute. The yarn was impregnated a second time under the same conditions.

Thus, fibers having the following mechanical properties were obtained (properties differing depending on the direction of twisting because of the production dispersion):

Z-twist:

load at break: 74.90 kg; elongation at break: 1.21%; elongation under a load of 30% of the load at break: 0.56%;

S-twist:

load at break: 70.93 kg; elongation at break: 1.28%; elongation under a load of 30% of the load at break: 0.62%.

These fibers were particularly suitable for being incorporated into timing belts.

### EXAMPLE 4

A fiber identical to that of example 3 was used. The tension with which the fiber was delivered from the creel was 30 grams. Each fiber was splayed out by two bars 1 millimeter in diameter, separated by 39 mm, that were immersed in the coating tank.

The impregnation solution was the same as that used in example 3, with a solids content adjusted to 330 g/kg.

The speed of the fibers through the impregnation bath was about 20 meters per minute. On leaving the impregnation bath, the yarn was passed through a die 0.81 millimeters in diameter and the fiber then passed through a curing oven, again at a speed of 20 meters per minute; the temperature of the oven was 180° C. The length of the oven was 3 meters. On leaving the oven, the fiber had a coating, corresponding to the amount of cured impregnation solution material, representing approximately 19.8% by dry weight of the yarn.

The fibers thus obtained were then twisted as in example 3, but under a tension close to only 20 kg.

Next, the cabled yarn thus obtained underwent an additional treatment identical to that of example 3.

Thus, a fiber having the following mechanical properties was obtained:

Z-twist:

load at break: 77.00 kg; elongation at break: 1.14%; elongation under a load of 30% of the load at break: 0.51%;

S-twist:

load at break: 85.99 kg; elongation at break: 1.26%; elongation under a load of 30% of the load at break: 0.57%.

These fibers are particularly suitable for being incorporated into timing belts.

### EXAMPLE 5

A fiber sold by Toray under the reference TOPAYCA-700 GC 4 12K, corresponding to a yarn of 800 tex overall linear density and comprising 12 000 filaments, was used. The tension with which the fiber was delivered from the creel was 100 grams. Each fiber was splayed out by two bars 1 mm in diameter, separated by 34 mm, that were immersed in the impregnation tank.

The impregnation solution was the same as that of example 3.

The speed of the fibers through the impregnation bath was about 40 meters per minute. On leaving the impregnation bath, the yarn was passed through a die 1.1 millimeters in diameter and the fiber then passed through a drying oven, again at a speed of 40 meters per minute. The temperature of the drying oven was 146° C. The length of the drying oven was 3 meters. On leaving the drying oven, the fiber passed through a curing oven, again at a speed of 40 m/min. The temperature of the curing oven was 249° C. The length of the curing oven was 5 meters. The fiber had a coating, corresponding to the amount of cured impregnation solution material, representing approximately 17.5% by dry weight of the yarn.

The fibers thus obtained were then twisted with 80 turns per meter. This twisting operation was carried out under a tension close to 50 kg. One fiber was Z-twisted and one fiber S-twisted.

Next, the twisted yarn thus obtained underwent the same additional treatment as that explained in example 3.

Thus, fibers having the following mechanical properties were obtained:

Z-twist:

load at break: 93.10 kg; elongation at break: 1.40%; elongation under a load of 30% of the load at break: 0.63%;

S-twist:

load at break: 115.10 kg; elongation at break: 1.55%; elongation under a load of 30% of the load at break: 0.69%.

These fibers are particularly suitable for being incorporated into timing belts.

### EXAMPLE 6

A fiber sold by Toray under the reference TORAYCA-700 GC 4 12K, corresponding to a yarn of 800 tex overall linear density and comprising 12 000 filaments, was used. The tension with which the fiber was delivered from the creel was 100 grams. Each fiber was splayed out by two bars 1 mm in diameter, separated by 34 mm, that were immersed in the impregnation tank.

The impregnation solution was obtained by mixing:

a first part A composed of:

36 liters of deionized water,

4 liters of 20.5% aqueous ammonia of Vaissière Favre brand,

10 kilograms of PENACOLITE of reference R-2170 (75% concentration) sold by Indspec Chemical Corp.,

27.2 kilograms of 41% urea of Vaissière Favre brand;

a second part B composed of:

64 liters of deionized water,

143 kilograms of Zetpol B latex sold by Nippon Zeon,

115 kg of CHEMLOK E0872 latex sold by Lord Corporation; and

a third part C composed of:

16 liters of deionized water,

3.2 kilograms of 37% formaldehyde of Vaissière Favre brand.

Next, 18 kilograms of HEVEAMUL M-111b wax (45%) sold by Heveatex were added.

The speed of the fibers through the impregnation bath was about 30 meters per minute. On leaving, the impregnation bath, the yarn was passed through a die 1.1 millimeters in diameter and the fiber then passed through a drying oven, again at a speed of 30 meters per minute. The temperature of the drying oven was 146° C. The length of the drying oven was 3 meters. On leaving the drying oven, the fiber passed through a curing oven, again at a speed of 30 m/min. The temperature of the curing oven was 249° C. The length of the curing oven was 5 meters. The fiber had a coating, corresponding to the amount of cured impregnation solution material, representing approximately 18.3% by dry weight of the yarn.

The fibers thus obtained were then twisted with 80 turns per meter. This twisting operation was carried out under a tension close to 50 kg. One fiber was Z-twisted and one fiber S-twisted.

Next, the twisted yarn thus obtained underwent the same additional treatment as that explained in example 3.

Thus, fibers having the following mechanical properties were obtained:

Z-twist:

load at break: 97.9 kg; elongation at break: 1.74%; elongation under a load of 30% of the load at break: 0.72%;

S-twist:

load at break: 105.2 kg; elongation at break: 1.81%; elongation under a load of 30% of the load at break: 0.74%.

These fibers are particularly suitable for being incorporated into timing belts.

### EXAMPLE 7

A fiber sold by Toray under the reference TORAYCA-700 GC 4 12K, corresponding to a yarn of 800 tex overall linear density and comprising 12 000 filaments, was used. The tension with which the fiber was delivered from the creel was 100 grams. The splaying was provided out by two bars 1 mm in diameter, separated by 34 mm, that were immersed in the impregnation tank.

The impregnation solution was obtained by mixing:

a first part A composed of:

36 liters of deionized water,

4 liters of 20.5% aqueous ammonia of Vaissière Favre brand,

10 kilograms of PENACOLITE of reference R-2170 (75% concentration) sold by Indspec Chemical Corp.,

27.2 kilograms of 41% urea of Vaissière Favre brand;

a second part B composed of:

38.6 liters of deionized water,

143 kilograms of Zetpol B latex sold by Nippon Zeon,

115 kg of PLIOCORD VP106 latex (40%) sold by Goodyear Chemicals; and

a third part C composed of:

16 liters of deionized water,

3.2 kilograms of 37% formaldehyde of Vaissière Favre brand.

Next, the following were added:

18 kilograms of Heveamul M-111b wax (45%) sold by Heveatex;

8.7 kg of an antioxidant derived from aromatic amines (60%); and

17.5 kg of DERUSSOL 345 carbon black (50%) sold by Degussa.

The speed of the fibers through the impregnation bath was about 30 meters per minute. On leaving the impregnation bath, the yarn was passed through a die 1.1 millimeters in diameter and the fiber then passed through a drying oven, again at a speed of 30 meters per minute. The temperature of the drying oven was 146° C. The length of the drying oven was 3 meters. On leaving the drying oven, the fiber passed through a curing oven, again at a speed of 30 m/min. The temperature of the curing oven was 249° C. The length of the curing oven was 5 meters. The fiber had a coating, corresponding to the amount of cured impregnation solution material, representing approximately 17.3% by dry weight of the yarn.

The fibers thus obtained were then twisted with 80 turns per meter. This twisting operation was carried out under a tension close to 50 kg. One fiber was Z-twisted and one fiber S-twisted.

Next, the twisted yarn thus obtained underwent the same additional treatment as that explained in example 3.

Thus, fibers having the following mechanical properties were obtained:

Z-twist:

load at break: 108.43 kg; elongation at break: 1.79%; elongation under a load of 30% of the load at break: 0.82%;

S-twist:

load at break: 109 kg; elongation at break: 1.67%; elongation under a load of 30% of the load at break: 0.73%.

These fibers are particularly suitable for being incorporated into timing belts.

### EXAMPLE 8

A fiber sold by Tenax Fibers GmbH & Co. KG under the reference TENAX UTS 5631 12K, corresponding to a yarn of 800 tex overall linear density and comprising 12 000 filaments, was used. The tension with which the fiber was delivered from the creel was about 100 grams. The splaying was provided by two bars 5 millimeters in diameter placed in the impregnation tank.

The impregnation solution was obtained by mixing:

a first part A composed of:

36 liters of deionized water,

4 liters of 20.5% aqueous ammonia of Vaissière Favre brand,

10 kilograms of PENACOLITE of reference R-2170 (75% concentration) sold by Indspec Chemical Corp.,

27.2 kilograms of 41% urea of Vaissière Favre brand;

a second part B composed of:

36 liters of deionized water,

286 kilograms of Zetpol B latex sold by Nippon Zeon; and

a third part C composed of:

16 liters of deionized water,

3.2 kilograms of 37% formaldehyde of Vaissière Favre brand.

The solids content was 330 g/kg.

The speed of the fibers through the impregnation bath was about 15 meters per minute. On leaving the impregnation bath, the yarn was passed through a die 0.81 millimeters in diameter and the fiber then passed through a drying oven, again at a speed of 15 meters per minute. The temperature of the drying oven was 120° C. The length of the drying oven was 3 meters. On leaving the drying oven, the fiber passed through a curing oven, again at a speed of 15 m/min. The temperature of the curing oven was 230° C. The length of the curing oven was 5 meters. The fiber had a coating, corresponding to the amount of cured impregnation solution material, representing approximately 17.7% by dry weight of the yarn.

The fibers thus obtained were twisted with 60 turns per meter. This twisting operation was carried out under a tension close to 50 kg. One fiber was Z-twisted and one fiber S-twisted.

Next, the twisted yarn thus obtained underwent an additional treatment. Thus, the twisted yarn was paid out under a tension of about 1 kilogram. It was impregnated with a solution comprising 8.1% of a composition sold by Henkel under the reference CHEMOSIL X2410 in xylene. After impregnation, the fiber passed through an oven 8 meters in length at a temperature of 90° C. The speed of the yarn through the oven was 18 meters per minute. The yarn was impregnated a second time under the same conditions.

Thus, fibers having the following mechanical properties were obtained:

Z-twist:

load at break: 102.39 kg; elongation at break: 1.85%; elongation under a load of 30% of the load at break: 0.96%;

S-twist:

load at break: 84.94 kg; elongation at break: 1.64%; elongation under a load of 30% of the load at break: 0.83%.

These fibers are particularly suitable for being incorporated into timing belts.

### EXAMPLE 9

A fiber sold by Toray under the reference TORAYCA-700 GC 4 12K, corresponding to a yarn of 800 tex overall linear density and comprising 12 000 filaments, was used. The tension with which the fiber was delivered from the creel was 100 grams. The splaying was provided by two bars 1 mm in diameter separated by 34 mm immersed in the impregnation tank.

The impregnation solution was obtained by mixing:

a first part A composed of:

36 liters of deionized water,

4 liters of 20.5% aqueous ammonia of Vaissière Favre brand,

10 kilograms of PENACOLITE of reference R-2170 (75% concentration) sold by Indspec Chemical Corp.,

27.2 kilograms of 41% urea of Vaissière Favre brand;

a second part B composed of:

230.4 kilograms of CHEMLOK E0872 latex sold by Lord Corporation; and

a third part C composed of:

16 liters of deionized water,

3.2 kilograms of 37% formaldehyde of Vaissière Favre brand.

Next, 28.8 kg of DENABOND sold by Nagase were added.

To obtain the impregnation solution ready to be used, the mixture thus obtained was diluted so as to have a solids content of 240 g/kg.

The speed of the fibers through the impregnation bath was about 30 meters per minute. On leaving the impregnation bath, the yarn was passed through a die 1.1 millimeters in diameter and the fiber then passed through a drying oven, again at a speed of 30 meters per minute. The temperature of the drying oven was 146° C. The length of the drying oven was 3 meters. On leaving the drying oven, the fiber passed through a curing oven, again at a speed of 30 m/min. The temperature of the curing oven was 285° C. The length of the curing oven was 5 meters. The fiber had a coating, corresponding to the amount of cured impregnation solution material, representing approximately 10% by dry weight of the yarn.

The fibers thus obtained were then twisted with 60 turns per meter. This twisting operation was carried out under a tension close to 50 kg. One fiber was Z-twisted and one fiber S-twisted.

Next, the twisted yarn thus obtained underwent an additional treatment. Thus, the twisted yarn was paid out under a tension of about 1 kilogram. It was impregnated with a solution comprising 8.2% of a composition sold by Compounding Ingredient Limited under the reference CILBOND 80 in xylene. After impregnation, the fiber passed through an oven 8 meters in length at a temperature of 90° C. The speed of the yarn through the oven was 18 meters per minute. The yarn was impregnated a second time under the same conditions.

Thus, fibers having the following mechanical properties were obtained:

Z-twist:

load at break: 126.27 kg; elongation at break: 1.81%; elongation under a load of 30% of the load at break: 0.66%;

S-twist:

load at break: 118.47 kg; elongation at break: 1.72%; elongation under a load of 30% of the load at break: 0.64%.

These fibers are particularly suitable for being incorporated into timing belts.

It is apparent from the foregoing that the process according to the invention allows fibers to be obtained that have a better tensile strength than the existing fibers. Furthermore, such fibers have an initial low-tension elongation that is markedly less than that observed in existing fibers. These fibers can therefore be used very particularly as a reinforcing element in rubber timing belts, tires and tubings.

1. A process for manufacturing a longitudinal reinforcing element based on multifilament carbon fiber, to be incorporated into a rubber-based article, which includes the following steps, consisting, starting from twist-free carbon fibers:
in immersing the fibers in an impregnation bath containing a solution of resorcinol-formaldehyde resin and of rubber latex;
in drying the impregnated fibers;
then in twisting the dried fibers,
characterized in that it also includes a step that consists, during the impregnation step, in opening the carbon fibers by spreading the constituent filaments so that each fiber has an increased surface area on which the impregnation may take place.

2. The process as claimed in claim 1, characterized in that the fibers are opened by splaying.

3. The process as claimed in claim 2, characterized in that the splaying is obtained by passing the fibers around part of the circumference of at least one bar placed perpendicular to the path of the fibers.

4. The process as claimed in claim 2, characterized in that the yarns are opened by exposing the fibers to a source of vibration.

5. The process as claimed in claim 1, characterized in that, in the resorcinol-formaldehyde-latex solution, the fraction of resorcinol-formaldehyde resin represents from 2 to 30% by dry weight, the fraction of latex representing from 70 to 98%.

6. The process as claimed in claim 5, characterized in that, in the resorcinol-formaldehyde-latex solution, the fraction of resorcinol-formaldehyde resin representing from 5 to 10% by dry weight.

7. The process as claimed in claim 5, characterized in that up to 10% by dry weight of carbon black is added to the resorcinol-formaldehyde-latex solution, the resorcinol-formaldehyde resin and latex fractions remaining in the same ratios, so as to adapt the stiffness of the fiber.

8. The process as claimed in claim 7, characterized in that up to between 1 and 4% by dry weight of carbon black is added to the resorcinol-formaldehyde-latex solution, the resorcinol-formaldehyde resin and latex fractions remaining in the same ratios.

9. The process as claimed in claim 1, characterized in that the latex used comprises, by itself or as a mixture, a latex chosen from the group comprising: vinylpyridine/styrene-butadiene (VP/SBR), styrene-butadiene (SBR), the latex of natural rubber (NR), carboxylated and hydrogenated acrylonitrile-butadiene (X-HNBR), hydrogenated acrylonitrile (HNBR), acrylonitrile (NBR), chlorosulfonated polyethylene (CSM) and ethylene-propylene-diene monomer (EPDM).

10. The process as claimed in claim 1, characterized in that it includes, after the impregnation step and before the drying step, a step of sizing the coating.

11. The process as claimed in claim 10, characterized in that the sizing is obtained by passing the fibers through a die.

12. The process as claimed in claim 10, characterized in that the sizing is obtained by padding the impregnated fibers.

13. The process as claimed in claim 1, characterized in that it includes, after the drying step, a step of heating the fibers so as to be able to cure the fraction of resorcinol-formaldehyde resin/latex solution impregnated into the fibers.

14. The process as claimed in claim 1, characterized in that, after the drying step, several fibers are combined and then receive a twist by cabling.

15. The process as claimed in claim 1 or 14, characterized in that the cabling/twisting is carried out under tension.

16. The process as claimed in claim 15, characterized in that the tension exerted during the twisting/cabling is at least equal to 5% of the load at break of the fiber.

17. The process as claimed in claim 1, characterized in that it furthermore includes a step of impregnating the cabled or twisted fiber, in a solution of an adhesive in a solvent medium.

18. The process as claimed in claim 17, characterized in that the solution of an adhesive in a solvent medium contains halogenated polymers.

19. A carbon fiber capable of being obtained by the process as claimed in one of claims 1 to 18.

20. A tire incorporating a carbon fiber as claimed in claim 19.
